(19) United States
(12) Patent Application Publication
(10) Pub. No.: US 2021/0122357 A1
(43) Pub. Date: Apr. 29, 2021

(54) DRIVE ARRANGEMENT PERMITTING DRIVING OF A VEHICLE BY AN ELECTRIC MOTOR

(71) Applicant: LITENS AUTOMOTIVE PARTNERSHIP, Woodbridge (CA)

(72) Inventors: Jun XU, Woodbridge (CA); Andrew M. BOYES, Aurora (CA); John R. ANTCHAK, West Aurora (CA)

(21) Appl. No.: 16/623,244

(22) PCT Filed: Jun. 18, 2018
(86) PCT No.: PCT/CA2018/050739

§ 371 Date: Dec. 16, 2019

Related U.S. Application Data
(60) Provisional application No. 62/521,067, filed on Jun. 16, 2017.

(51) Int. Cl. B60W 20/40; B60W 10/06; B60W 10/08; B60W 10/02; B60W 10/26; B60K 6/387; F16D 41/20

(52) U.S. Cl. CPC B60W 20/40; B60W 10/06; B60W 10/08; B60W 10/02; B60Y 2400/427; B60K 6/387; F16D 41/20; B60Y 2200/92; B60W 10/26

(57) ABSTRACT

In an aspect, a drive arrangement for a vehicle is provided, comprising: an engine having a crankshaft; a crankshaft pulley; a one-way clutch between the crankshaft pulley and the crankshaft; a belt by the crankshaft pulley; and an electric motor having a pulley engaged with the belt. When the electric motor drives the belt in a first direction, the one-way clutch permits the belt to overrun the crankshaft pulley. The crankshaft defines an axis. The electric motor pulley is on a first axial side of the engine. A transmission is on a second axial side and is operatively connected to drive a vehicle wheel. The transmission has an input shaft. A first rotary drive member is on the input shaft; and a motor-transmission drive shaft is drivable by the motor and has a second rotary drive member thereon, which is operatively connected with the first transmission rotary drive member.

### CROSS-REFERENCE

This application claims the benefit of U.S. Provisional Application No. 62/521,067 filed Jun. 16, 2017, the contents of which are incorporated by reference herein.

### FIELD

This disclosure generally relates to hybrid vehicles, and more particularly to drive arrangements for transmitting power in a hybrid vehicle.

### BACKGROUND

Hybridization and electrification of vehicles are gaining more and more attention due to the targets of fuel consumption and emissions that need to be met in the near future. The share of HEVs (Hybrid Electric Vehicles) and BEVs (Battery Electric Vehicles) has increased continuously in recent years.

The functionality provided by hybrid powertrains for such vehicles can be one or more of, start/stop capability (which permits the engine to shut off when the vehicle is stopped temporarily, such as at a stoplight), generation of electricity during vehicle braking so as to recover the kinetic energy of the vehicle, boost and/or E-drive, wherein the vehicle is driven solely using an electric motor, or using an electric motor in combination with the engine.

Some of the systems on the market today require two separate electric motors, i.e. one traction motor and one motor/generator. For such vehicles, besides the costs of the two motors, the powertrain and transmission typically need to be redesigned in order to operate with the motor and the engine to drive the vehicle's wheels. As a result, the cost of a many hybrid vehicles is relatively high.

There is, therefore, a continuing need for improvements in hybrid vehicles in order to reduce their cost, while still providing useful functionality.

### SUMMARY

In an aspect, a drive arrangement for a vehicle is provided, comprising: an engine having a crankshaft; a crankshaft pulley that is drivable by the engine; a one-way clutch between the crankshaft pulley and the crankshaft; an endless drive member drivable in a first rotational direction by the crankshaft pulley through the one-way clutch by the engine; and an electric motor having an electric motor pulley that is engaged with the endless drive member, wherein, when the electric motor is operated to rotate the electric motor pulley to drive the endless drive member in the first rotational direction, the one-way clutch permits the endless drive member to overrun the crankshaft pulley, wherein the crankshaft defines a longitudinal engine axis and wherein the electric motor pulley is on a first axial side of the engine; a transmission on a second axial side of the engine, wherein the transmission is operatively connected to drive at least one ground-engaging wheel, the transmission having a transmission input shaft; a first transmission rotary drive member on the transmission input shaft; and a motor-transmission drive shaft that is drivable by the electric motor and which has a second transmission rotary drive member thereon, which is operatively connected with the first transmission rotary drive member.

In another aspect, a drive arrangement is provided for a vehicle, comprising: an engine having a crankshaft; an endless drive member drivable in a first rotational direction by the crankshaft pulley through the crankshaft pulley clutch by the engine; a crankshaft-endless drive member clutch between the crankshaft and the endless drive member; a transmission operatively connected to drive at least one ground-engaging wheel; a crankshaft-transmission clutch between the crankshaft and the transmission, and positionable in a drive position in which the crankshaft-transmission clutch operatively connects the crankshaft and the transmission and a disconnect position in which the crankshaft-transmission clutch operatively disconnects the crankshaft from the transmission; an electric motor having an electric motor pulley that is engaged with the endless drive member, wherein, when the electric motor is operated to rotate the electric motor pulley to drive the endless drive member in the first rotational direction, the first clutch permits the endless drive member to overrun the crankshaft pulley, a motor-transmission clutch operatively connected between the electric motor and the transmission along a torque flow path that bypasses the engine, wherein the motor-transmission clutch is positionable in an engagement position in which the motor-transmission clutch operatively connects the electric motor to the transmission such that the electric motor is operable to drive the at least one ground-engaging wheel through the transmission when the crankshaft-transmission clutch is in the disconnect position, and a disengagement position in which the electric motor is operatively disconnected from the transmission.

In yet another aspect, a drive arrangement is provided for a vehicle, comprising: an engine having a crankshaft; a transmission operatively connected to drive at least one ground-engaging wheel, wherein the engine is operatively connectable to the transmission along an engine-transmission torque flow path between the crankshaft and the transmission; a crankshaft-transmission clutch between the crankshaft and the transmission, and positionable in a drive position in which the crankshaft-transmission clutch operatively connects the crankshaft to the engine-transmission torque flow path and a disconnect position in which the crankshaft-transmission clutch operatively disconnects the crankshaft from the engine-transmission torque flow path; an endless drive member; at least one accessory having an accessory pulley that is engaged with the endless drive member so as to be driven thereby; an electric motor having an electric motor pulley that is engaged with the endless drive member; a motor-transmission clutch operatively connected between the electric motor and the transmission along a motor-transmission torque flow path that bypasses the engine, wherein the motor-transmission clutch is positionable in an engagement position in which the motor-transmission clutch operatively connects the electric motor to the motor-transmission torque flow path so as to permit the electric motor to drive the at least one ground-engaging wheel through the transmission when the crankshaft-transmission clutch is in the disconnect position, and a disengagement position in which the electric motor is operatively disconnected from the motor-transmission torque flow path, wherein the electric motor is operable to rotate the electric motor pulley to drive the endless drive member.

In yet another aspect, a drive arrangement is provided for a vehicle, comprising: an engine having a crankshaft; a crankshaft pulley that is drivable by the engine; a crankshaft pulley clutch between the crankshaft pulley and the crankshaft; an endless drive member drivable in a first rotational direction by the crankshaft pulley through the crankshaft pulley clutch by the engine; a transmission operatively connected to drive at least one ground-engaging wheel, the transmission having a transmission input shaft; a crankshaft-transmission clutch between the crankshaft and the transmission input shaft, and positionable in a drive position in which the crankshaft-transmission clutch operatively connects the crankshaft and the transmission input shaft and a disconnect position in which the crankshaft-transmission clutch operatively disconnects the crankshaft from the transmission input shaft; an electric motor having an electric motor pulley that is operatively connected to the endless drive member, wherein, when the electric motor is operated to rotate the electric motor pulley to drive the endless drive member in the first rotational direction, the first clutch permits the endless drive member to overrun the crankshaft pulley, a motor-transmission drive shaft that is drivable by the electric motor; a first transmission rotary drive member on the transmission input shaft; a second transmission rotary drive member on the motor-transmission drive shaft and operatively connected with the first transmission rotary drive member; a motor-transmission clutch operatively connected between the electric motor and the transmission along a torque flow path that bypasses the engine and which includes the motor-transmission drive shaft and the first and second transmission rotary drive members, wherein the motor-transmission clutch is positionable in an engagement position in which the motor-transmission clutch operatively connects the electric motor to the transmission such that the electric motor is operable to drive the at least one ground-engaging wheel through the transmission when the crankshaft-transmission clutch is in the disconnect position, and a disengagement position in which the electric motor is operatively disconnected from the transmission.

### BRIEF DESCRIPTION OF THE DRAWINGS

The foregoing and other aspects of the invention will be better appreciated having regard to the attached drawings, wherein:

FIG. 1A is a schematic view of a vehicle;

FIG. 1B is a perspective view of an engine in the vehicle shown in FIG. 1A;

FIG. 2 is a perspective view of a portion of the engine shown in FIG. 1B, and a portion of a drive arrangement in accordance with an embodiment of the present disclosure;

FIG. 3 is a simplified plan view of the engine and the drive arrangement shown in FIG. 2;

FIG. 4 is a perspective view of a portion of the engine shown in FIG. 1B, and a portion of a drive arrangement in accordance with another embodiment of the present disclosure;

FIG. 5 is a simplified plan view of the engine and the drive arrangement shown in FIG. 4;

FIG. 6 is a perspective view of a portion of the engine shown in FIG. 1B, and a portion of a drive arrangement in accordance with yet another embodiment of the present disclosure;

FIG. 7 is a simplified plan view of the engine and the drive arrangement shown in FIG. 6;

FIG. 8 is a perspective view of a portion of the engine shown in FIG. 1B, and a portion of a drive arrangement in accordance with yet another embodiment of the present disclosure;

FIG. 9 is a simplified plan view of the engine and the drive arrangement shown in FIG. 8;

FIG. 10 is a perspective view of a portion of the engine shown in FIG. 1B, and a portion of a drive arrangement in accordance with yet another embodiment of the present disclosure;

FIG. 11 is a simplified plan view of the engine and the drive arrangement shown in FIG. 10; and

FIG. 12 is an example of a decoupler containing a crankshaft pulley shown in FIG. 1 along with a one-way clutch.

### DETAILED DESCRIPTION OF EXAMPLE EMBODIMENTS

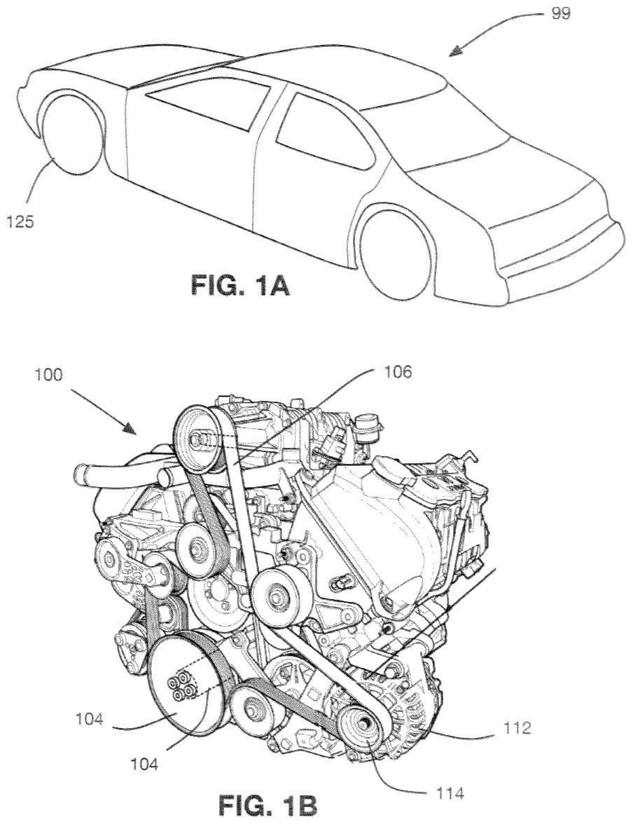

Reference is made to FIG. 1B, which schematically shows an internal combustion engine 100 for a vehicle 99 shown in FIG. 1A. The engine 100 may be any suitable kind of engine, such as a gasoline engine.

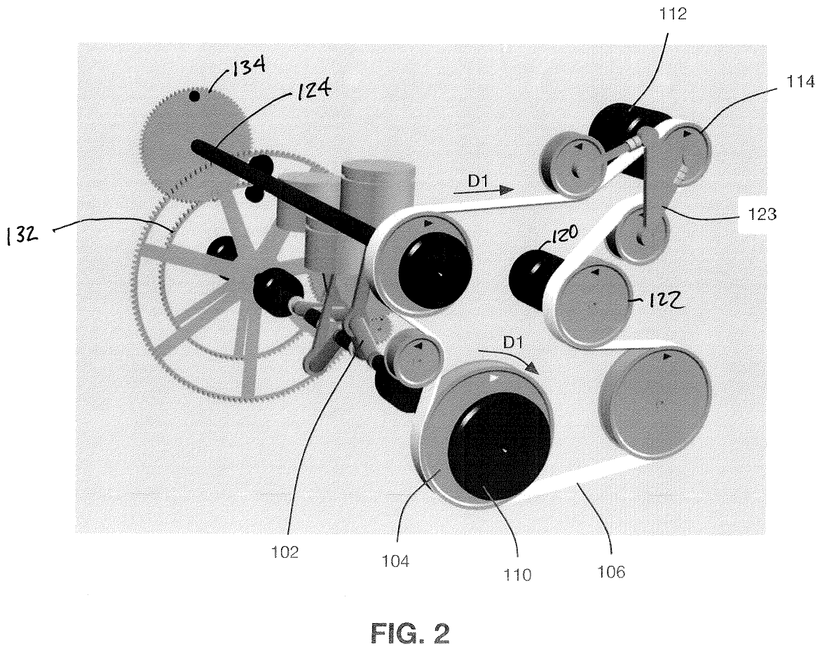

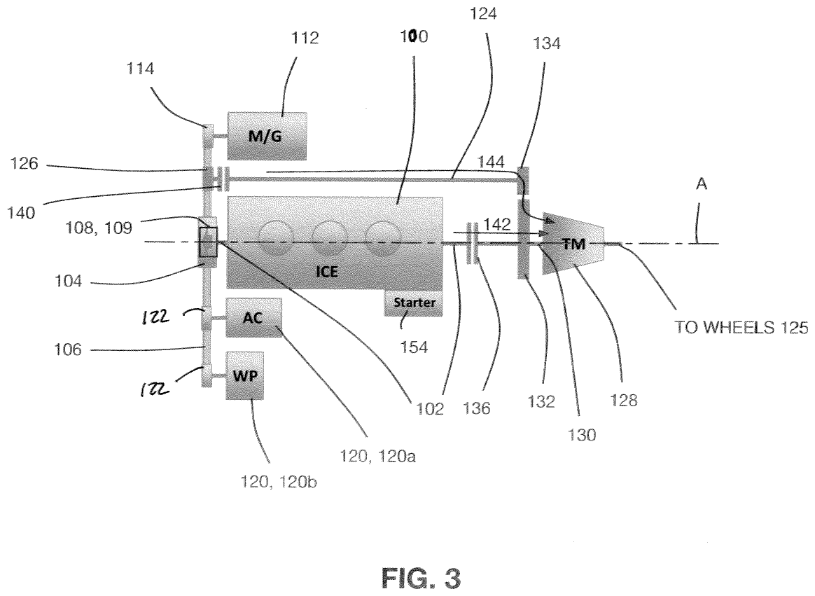

The engine 100 includes a crankshaft 102 (see FIG. 2), which defines a longitudinal axis A (see FIG. 3) for the engine 100. The engine 100 is shown in FIGS. 2 and 3 as being a three-cylinder engine, however it will be understood that it may have any other suitable number of cylinders such as four cylinders. The crankshaft 100 has a crankshaft rotary drive member 104 thereon. In the embodiment shown in FIG. 2, the crankshaft rotary drive member 104 is a crankshaft pulley. The crankshaft rotary drive member 104 is drivable by the crankshaft 102 (and therefore by the engine 100) in a first rotational direction D1 (shown in FIG. 2). In the example shown the first rotational direction is clockwise from the viewpoint of a person viewing FIG. 2. An endless drive member 106 is drivable in the first rotational direction D1 by the crankshaft rotary drive member 104. The endless drive member 106 may be, for example, a belt, such as a poly-V belt as is used on accessory drives of many vehicles currently. Alternatively, any other suitable type of endless drive member may be used, such as a toothed belt or a chain.

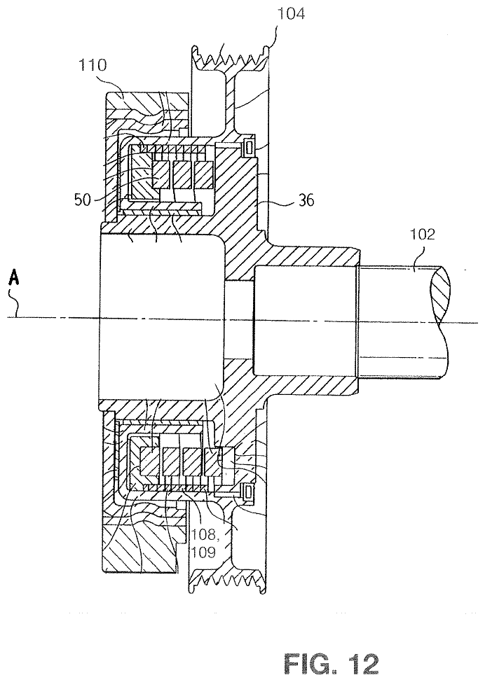

In the example shown in FIGS. 2 and 3, a clutch 108 is provided between the crankshaft 102 and the endless drive member 106. The clutch 108 may be, for example, a one-way clutch, shown at 109. In embodiments in which the clutch 108 is a one-way clutch it may be a wrap spring clutch as shown in FIG. 12. In the example shown in FIG. 12, the clutch 108 and the crankshaft rotary drive member 104 are provided in an assembly called a decoupler. The decoupler shown in FIG. 12 may be any suitable decoupler, such as that which is shown in FIG. 3 of U.S. Pat. No. 8,534,438, the contents of which are incorporated herein by reference. The decoupler shown in FIG. 3 includes, among other things, an isolation spring 50, the aforementioned wrap spring clutch 108, the pulley 104, and a hub 36 that is mountable to the crankshaft 102. As will be understood by one skilled in the art, the one-way clutch 109 permits the endless drive member 106 to overrun the crankshaft pulley 104 in the first rotational direction D1.

Any other suitable overrunning decoupler could alternatively be provided instead of the decoupler shown in FIG. 12.

An optional torsional vibration damper is shown at 110 for the crankshaft pulley 104. In the embodiment shown, the one-way clutch 109 is provided between the crankshaft pulley 104 and the crankshaft 102. The endless drive member 106 is drivable in the first rotational direction D1 by the crankshaft pulley 104 through the one-way clutch 109 by the engine 100.

An electric motor 112 is provided, and has an electric motor rotary drive member 114 (e.g. an electric motor pulley) that is engaged with the endless drive member 106. When the electric motor 112 is operated to rotate the electric motor pulley 114 to drive the endless drive member 106 in the first rotational direction, the one-way clutch 109 permits the endless drive member 106 to overrun the crankshaft pulley 104.

In the embodiment shown, the electric motor 112 is a motor/generator unit (MGU). The electric motor 112 is drivable by the crankshaft pulley 104 through the endless drive member 106 to generate electric power for storage in an electric power storage device (e.g. a vehicle battery (not shown). In embodiments where an MGU 112 is used as the electric motor, a tensioner 123 may be used to maintain tension in the endless drive member 106, particularly where the endless drive member 106 is a belt. The tensioner 123 may be any suitable tensioner, such as an MGU mounted tensioner with two arms, as shown in U.S. Pat. No. 9,759,293, the contents of which are incorporated herein in their entirety.

While a one-way clutch 109 is advantageous for reducing stresses on various components during engine shutdown, for example, its presence, in some embodiments, prevents the MGU 112 from applying torque to the crankshaft 102 through the crankshaft pulley 104 and from driving the vehicle's wheels 125 (also referred to as ground engaging wheels 125) through the crankshaft pulley 104. However, the presence of the one-way clutch 109 does permit the MGU 112 to drive some accessories shown at 120 via the endless drive member 106, when the engine 100 is off, without driving the crankshaft 102. The accessories 120 may include, for example, an air-conditioning compressor 120a, a water pump 120b. Each accessory 120 includes an accessory pulley 122 that is engaged with the endless drive member 106. This permits the occupants of the vehicle 99 to enjoy the use of these accessories 120 while the engine is 100. This facilitates the use of a stop/start system for the vehicle 99, wherein the engine 100 is shut down when the vehicle 99 is stopped temporarily, e.g. at a stoplight.

In addition to this functionality, however, the MGU 112 may be provided with the capability to drive the vehicle 99. In the example shown in FIGS. 2 and 3, the MGU-transmission drive pulley 126 that is itself engaged with and driven by the endless drive member 106. The motor-transmission drive pulley 126 is operatively connected to a transmission 128 of the vehicle 99. In the example shown in FIG. 3, the transmission 128 (which drives the wheels 125 of the vehicle 99) has a transmission input shaft 130, on which there is a first transmission rotary drive member 132. A second transmission rotary drive member 134 is provided on the motor-transmission drive shaft 124. The first and second transmission rotary drive members 132 and 134 may be, for example, gears, chains, belts or any other suitable types of power transfer members. The engine 100 may also be operatively connected to the transmission input shaft 130, via the crankshaft 102. A crankshaft-transmission clutch 136 may be provided, which is operatively between the crankshaft 102 and the transmission 128, and which is positionable in a drive position in which the crankshaft-transmission clutch 136 operatively connects the crankshaft 102 and the transmission 128 and a disconnect position in which the crankshaft-transmission clutch 136 operatively disconnects the crankshaft 102 from the transmission 128. The crankshaft-transmission clutch 136 may be any suitable type of clutch such as a plate clutch.

With this arrangement, the MGU 112 may be driven as a motor, so as to drive the motor-transmission drive shaft 124, thereby driving the transmission 128, while the crankshaft-transmission clutch 136 is in the disconnect position. The permits the MGU 112 to drive the vehicle 99 bypassing the engine 100 thereby avoiding the drag that would be associated with driving the crankshaft 102 and pistons of the engine 100 when the engine 100 is off. The MGU 112 can be used to drive the vehicle 99 relatively slowly with relatively little torque, and therefore relatively little electrical power, thereby avoiding the need for a high-voltage motor and electrical system. This system can be used to drive the vehicle 99 in, for example, stop-and-go traffic. In some embodiments, the MGU 112 may have about 10-20 kW of power, and may have 60 nM or more of stall torque, whereby providing sufficient power and torque to drive a suitable vehicle at a suitable speed (e.g. less than 10 kph) for such purposes as keeping up in stop-and-go traffic, thereby eliminating the need to repeatedly restart the engine 100 only to move forward a few feet.

A motor-transmission clutch 140 may be provided and may be operatively connected between the MGU 112 and the transmission 128 along a torque flow path that bypasses the engine 100 (e.g. between the motor-transmission drive pulley 126 and the motor-transmission drive shaft 124). The motor-transmission clutch 140 is positionable in an engagement position in which the motor-transmission clutch 140 operatively connects the MGU 112 to the transmission 128 such that the MGU 112 is operable to drive the at least one ground-engaging wheel 125 through the transmission 128 when the crankshaft-transmission clutch 136 is in the disconnect position, and a disengagement position in which the electric motor 112 is operatively disconnected from the transmission 128. Repeated restarting of a vehicle's engine can lead to durability problems with certain components, NVH issues and can negatively affect driver comfort. It is therefore advantageous to be able to avoid this in at least some circumstances without the need for a second electric motor and the associated electrical system.

When it is desired to drive the vehicle wheels 125 using the engine 100, the crankshaft-transmission clutch 136 may be positioned in the drive position thereby operatively connecting the crankshaft 102 to the transmission 128, and the motor-transmission clutch 140 may be positioned in the disengagement position so as to disconnect the MGU 112 from the transmission 128. The engine 100 can then drive the vehicle's wheels 125. The engine 100 can also charge the vehicle battery (not shown) via the MGU 112 via the endless drive member 106.

The engine 100 could be used to drive the accessories 120 while the vehicle 99 is stationary if desired (in embodiments where the engine 100 can be kept running when the vehicle 99 is stopped), by moving both clutches 136 and 140 to the disengagement and disconnect positions respectively.

The MGU 112 could be used to provide boost to the engine 100 by having both clutches 136 and 140 in the drive and engagement positions respectively, thereby permitting power to be transmitted from both the engine 100 and the MGU 112 to the transmission 128.

The MGU 112 can be operated as a generator to capture braking energy (i.e. regenerative braking) by putting the clutch 136 in the drive position and the clutch 140 in the disconnect position, such that the MGU is operatively engaged with the crankshaft pulley 104 via the endless drive member 106. The resistance to rotation of the MGU 112 can be transmitted to the wheels 125, and can be used to charge the charge the vehicle's battery. Alternatively, the clutch 140 can be positioned in the engagement position, and the clutch 136 can be positioned in the disconnect position, and the braking torque of the MGU can be applied to the transmission 128 via the motor-transmission drive shaft 124, bypassing the engine 100.

Reference is made herein to torque flow paths. Two torque flow paths to the transmission are shown in FIG. 3. The engine 100 is operatively connectable to the transmission 128 along an engine-transmission torque flow path 142 between the crankshaft 102 and the transmission 128 (when the clutch 136 is in the drive position). The MGU 112 is operatively connectable to the transmission 128 along a motor-transmission torque flow path 144 between the MGU 112 and the transmission 128 (when the clutch 140 is in the engagement position).

It will be noted that the MGU pulley 114 is on a first axial side of the engine 100, and the transmission 128 is on a second axial side of the engine 100 (i.e. at the opposite end of the engine 100), and they are connected via the motor-transmission drive shaft 124. This can be a relatively efficient way of packaging the components of the drive arrangement and permitting power transfer to the MGU 112 via the endless drive member 106, while also permitting the MGU 112 to drive the vehicle's wheels 125 while bypassing the engine 100.

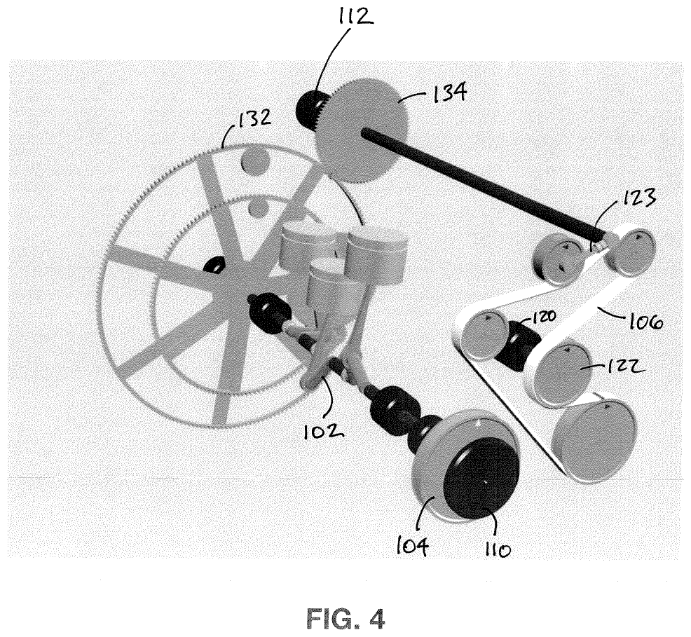

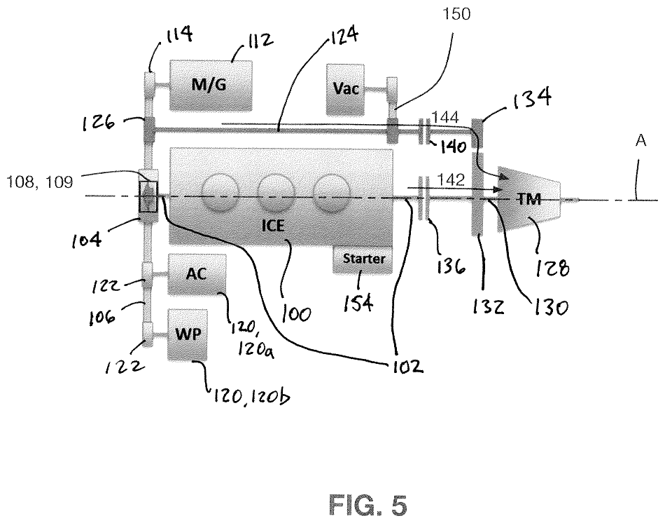

Reference is made to FIGS. 4 and 5, which show a variant of the drive arrangement. Only significant differences of this variant will be described. As can be seen, the variant in FIGS. 4 and 5 is similar to the embodiment in FIGS. 2 and 3, but the clutch 140 is moved towards the second axial side of the engine such that the motor- transmission drive shaft 124 is used to drive another accessory 120 (a vacuum pump), in this case via another endless drive member shown at 150.

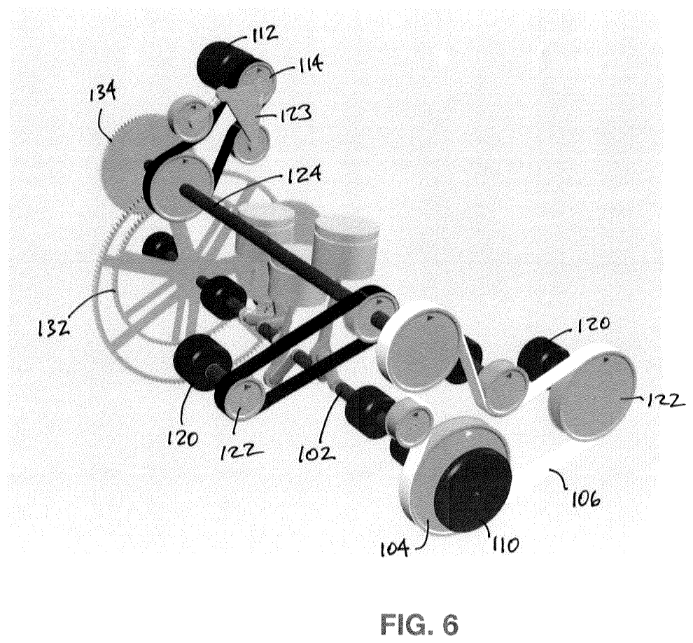

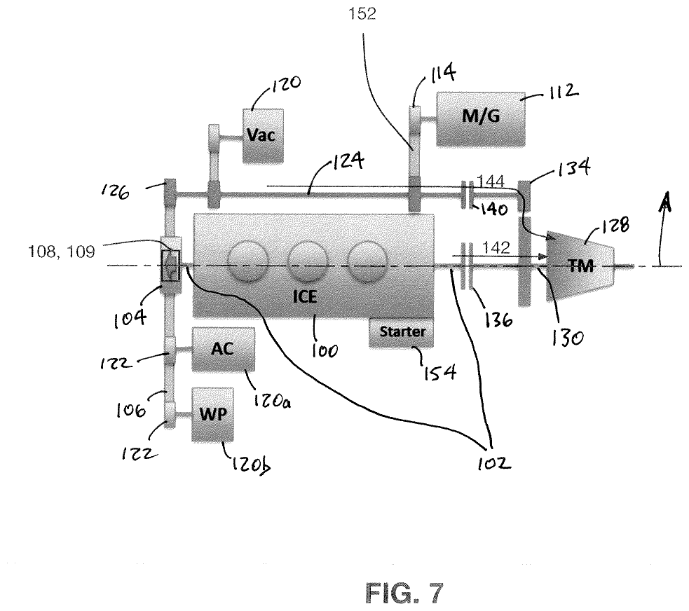

Reference is made to FIGS. 6 and 7, which show another variant of the drive arrangement. Only significant differences of this variant will be described. In this variant, the MGU 112 is operatively connected to the motor-transmission drive shaft 124 via a second endless drive member 152. This shows another packaging option that is possible thereby providing greater flexibility in the arrangement of the various components making up the drive arrangement.

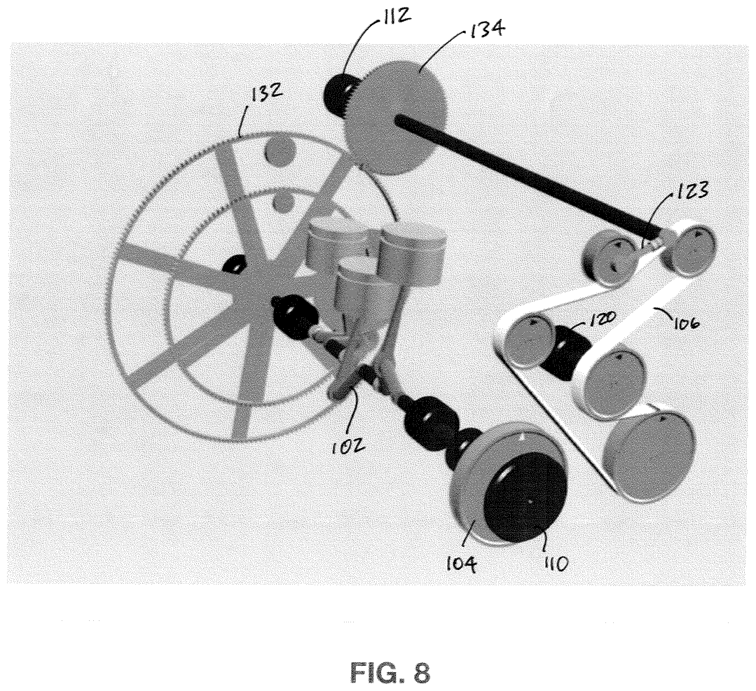

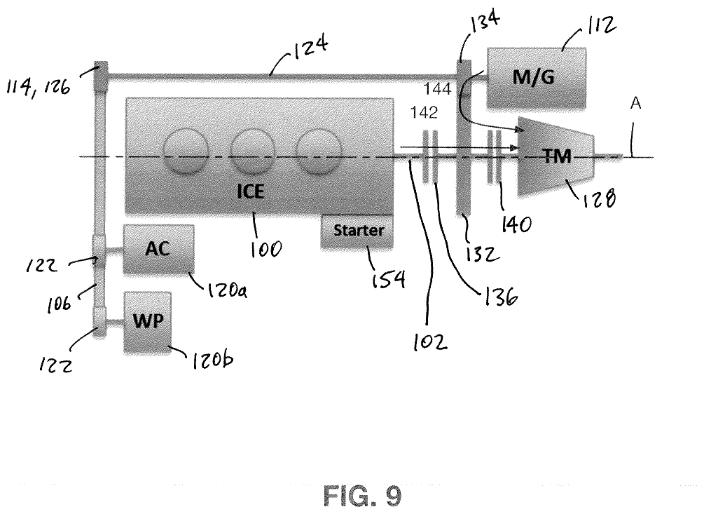

Reference is made to FIGS. 8 and 9, which show another variant of the drive arrangement. Only significant differences of this variant will be described. As can be seen, the crankshaft 102 lacks the pulley 104 to connect to the endless drive member 106. However, the engine 102 can drive the endless drive member 106 via the first and second transmission rotary drive members 132 and 134.

Additionally, the MGU 112 is directly connected to the motor-transmission drive shaft 124, instead of driving the shaft 124 via an endless drive member.

Additionally, the clutches 136 and 140 are provided inline with one another, on either side of the first transmission rotary drive member 132. This arrangement is narrower in the lateral direction (lateral being transverse to the axis A) than the embodiment shown in FIGS. 2-7. As a result, in this variant, in order to operatively connect the MGU 112 to the transmission 128 the clutch 140 is positioned in the engagement position and to disconnect the MGU 112 from the transmission 128 the clutch 140 is positioned in the disengagement position, as before. However, to operatively connect the engine 100 to the transmission 128 the clutch 140 is positioned in the engagement position and the clutch 136 is positioned in the drive position, and to disconnect the engine 100 from the transmission 128 the clutch 136 is in the disconnect position. It is optionally possible in at least this variant to eliminate the starter (shown at 154).

When it is desired for the engine 100 to drive the accessories while the vehicle 99 is stopped, the clutch 140 may be positioned in the disconnect position, and moving the clutch 136 to the drive position. The MGU 112 can be used as a generator driven by the engine 100 through the clutch 136 in the drive position, whether or not the clutch 140 is in the engagement or disengagement position.

The clutches 136 and 140 are positioned in the disconnect and disengagement positions respectively when it is desired to drive the accessories 120 via the MGU 112 when the vehicle 99 is stopped.

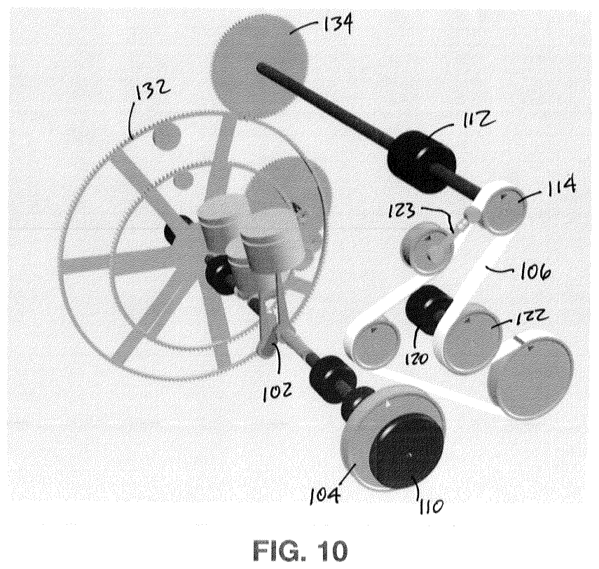

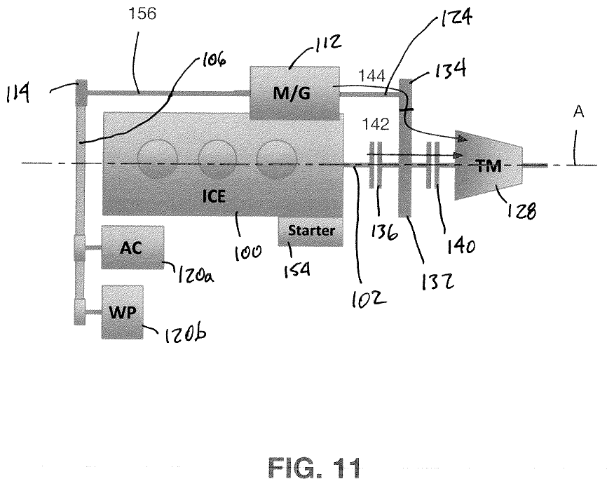

Reference is made to FIGS. 10 and 11, which show another variant of the drive arrangement. Only significant differences of this variant will be described. In this variant the MGU 112 has the motor-transmission drive shaft 124 extending out one end of the MGU 112 and an endless drive member drive shaft 156 extending out the opposing end of the MGU 112.

Other advantages and features will be understood by a person of skill in the art upon review of the present disclosure.

The MGU 112 is just an example of an electric motor that can be used in the embodiments disclosed herein. It is alternatively possible to use a dedicated electric motor and to have a separate generator in the drive arrangement.

In some embodiments the motor-transmission clutch 140 is on the motor-transmission drive shaft 124. This is advantageous as compared to hybrid systems that employ another clutch between the engine and the transmission, since the aforementioned motor-transmission clutch 140 requires the capability of handling much less torque than one between the engine and the transmission.

The drive arrangements described herein are preferably used in a vehicle that employs a 48V electrical systems. However, it is possible that the electric motor 112 can generate sufficient torque in a vehicle with an electrical system that has a lower voltage. It will be understood that higher voltage electrical systems are also contemplated.

Persons skilled in the art will appreciate that there are yet more alternative implementations and modifications possible, and that the above examples are only illustrations of one or more implementations. The scope, therefore, is only to be limited by the claims appended hereto.

1-7. (canceled)

8. A drive arrangement for a vehicle, comprising:
an engine having a crankshaft;
an endless drive member drivable in a first rotational direction by the crankshaft pulley through the crankshaft pulley clutch by the engine;
a crankshaft-endless drive member clutch between the crankshaft and the endless drive member;
a transmission operatively connected to drive at least one ground-engaging wheel;
a crankshaft-transmission clutch between the crankshaft and the transmission, and positionable in a drive position in which the crankshaft-transmission clutch operatively connects the crankshaft and the transmission and a disconnect position in which the crankshaft-transmission clutch operatively disconnects the crankshaft from the transmission;
an electric motor having an electric motor pulley that is engaged with the endless drive member, wherein, when the electric motor is operated to rotate the electric motor pulley to drive the endless drive member in the first rotational direction, the first clutch permits the endless drive member to overrun the crankshaft pulley,
a motor-transmission clutch operatively connected between the electric motor and the transmission along a torque flow path that bypasses the engine, wherein the motor-transmission clutch is positionable in an engagement position in which the motor-transmission clutch operatively connects the electric motor to the transmission such that the electric motor is operable to drive the at least one ground-engaging wheel through the transmission when the crankshaft-transmission clutch is in the disconnect position, and a disengagement position in which the electric motor is operatively disconnected from the transmission.

9. A drive arrangement as claimed in claim 8, wherein the crankshaft-endless drive member clutch is a one-way clutch permitting the endless drive member to overrun the crankshaft pulley in a first rotational direction.

10. A drive arrangement as claimed in claim 9, wherein the one-way clutch is a wrap spring clutch.

11. A drive arrangement as claimed in claim 8, wherein the electric motor is a motor-generator unit and is drivable by the crankshaft pulley through the endless drive member to generate electric power for storage in an electric power storage device.

12. A drive arrangement as claimed in claim 8, further comprising at least one accessory having an accessory pulley that is drivable by the endless drive member.

13. A drive arrangement as claimed in claim 8, wherein the crankshaft defines a longitudinal engine axis and wherein the electric motor pulley is on a first axial side of the engine, and wherein the transmission is on a second axial side of the engine.

14. A drive arrangement as claimed in claim 8, wherein the crankshaft-transmission clutch is operatively connected between the crankshaft and the first transmission rotary drive member, and the motor-transmission clutch is operatively connected between the first transmission rotary drive member and the transmission.

15. A drive arrangement as claimed in claim 8, wherein the crankshaft-transmission clutch is operatively connected between the crankshaft and the first transmission rotary drive member, and the motor-transmission clutch is operatively connected between the electric motor and the second transmission rotary drive member.

16. A drive arrangement for a vehicle, comprising:
an engine having a crankshaft;
a transmission operatively connected to drive at least one ground-engaging wheel, wherein the engine is operatively connectable to the transmission along an engine-transmission torque flow path between the crankshaft and the transmission;
a crankshaft-transmission clutch between the crankshaft and the transmission, and positionable in a drive position in which the crankshaft-transmission clutch operatively connects the crankshaft to the engine-transmission torque flow path and a disconnect position in which the crankshaft-transmission clutch operatively disconnects the crankshaft from the engine-transmission torque flow path;
an endless drive member;
at least one accessory having an accessory pulley that is engaged with the endless drive member so as to be driven thereby;
an electric motor having an electric motor pulley that is engaged with the endless drive member;
a motor-transmission clutch operatively connected between the electric motor and the transmission along a motor-transmission torque flow path that bypasses the engine, wherein the motor-transmission clutch is positionable in an engagement position in which the motor-transmission clutch operatively connects the electric motor to the motor-transmission torque flow path so as to permit the electric motor to drive the at least one ground-engaging wheel through the transmission when the crankshaft-transmission clutch is in the disconnect position, and a disengagement position in which the electric motor is operatively disconnected from the motor-transmission torque flow path,
wherein the electric motor is operable to rotate the electric motor pulley to drive the endless drive member.

17. A drive arrangement as claimed in claim 16, wherein the electric motor is operatively connected to the crankshaft to drive the engine when the crankshaft-transmission clutch is in the drive position.

18. A drive arrangement as claimed in claim 16, wherein the electric motor is a motor-generator unit and is drivable by the crankshaft pulley through the endless drive member to generate electric power for storage in an electric power storage device.

19. A drive arrangement for a vehicle, comprising:
an engine having a crankshaft;
a crankshaft pulley that is drivable by the engine;
a crankshaft pulley clutch between the crankshaft pulley and the crankshaft;
an endless drive member drivable in a first rotational direction by the crankshaft pulley through the crankshaft pulley clutch by the engine;
a transmission operatively connected to drive at least one ground-engaging wheel, the transmission having a transmission input shaft;
a crankshaft-transmission clutch between the crankshaft and the transmission input shaft, and positionable in a drive position in which the crankshaft-transmission clutch operatively connects the crankshaft and the transmission input shaft and a disconnect position in which the crankshaft-transmission clutch operatively disconnects the crankshaft from the transmission input shaft;
an electric motor having an electric motor pulley that is operatively connected to the endless drive member, wherein, when the electric motor is operated to rotate the electric motor pulley to drive the endless drive member in the first rotational direction, the first clutch permits the endless drive member to overrun the crankshaft pulley,
a motor-transmission drive shaft that is drivable by the electric motor;
a first transmission rotary drive member on the transmission input shaft;
a second transmission rotary drive member on the motor-transmission drive shaft and operatively connected with the first transmission rotary drive member;
a motor-transmission clutch operatively connected between the electric motor and the transmission along a torque flow path that bypasses the engine and which includes the motor-transmission drive shaft and the first and second transmission rotary drive members, wherein the motor-transmission clutch is positionable in an engagement position in which the motor-transmission clutch operatively connects the electric motor to the transmission such that the electric motor is operable to drive the at least one ground-engaging wheel through the transmission when the crankshaft-transmission clutch is in the disconnect position, and a disengagement position in which the electric motor is operatively disconnected from the transmission.
